(19) United States
(12) Patent Application Publication
(10) Pub. No.: US 2023/0382149 A1
(43) Pub. Date: Nov. 30, 2023

(54) METHOD FOR MANUFACTURING AN IDENTITY DOCUMENT, IDENTITY DOCUMENT AND METHOD FOR AUTHENTICATING SUCH AN IDENTITY DOCUMENT

(71) Applicant: IDEMIA FRANCE, Courbevoie (FR)

(72) Inventors: Benoît BERTHE, Courbevoie (FR); Olga SIARHEYEVA, Courbevoie (FR); Vranc DOUWMA, Courbevoie (FR); Marcel Johannes Leendert WEBER, Courbevoie (FR)

(73) Assignee: IDEMIA FRANCE, Courbevoie (FR)

(21) Appl. No.: 18/323,043

(22) Filed: May 24, 2023

(30) Foreign Application Priority Data
May 24, 2022 (FR) 2204968

(51) Int. Cl. B42D 25/435; B42D 25/45; B42D 25/23; B42D 25/309; G06V 20/00; G06V 30/42; B41M 3/14

(52) U.S. Cl. CPC B42D 25/435; B42D 25/45; B42D 25/23; B42D 25/309; G06V 20/95; G06V 30/42; B41M 3/14; G02B 5/208

(57) ABSTRACT

An identity document and method for manufacturing the identity document, the method including providing a document body that includes at least a first and a second transparent external layer and a white central layer, the white central layer including a transparent substrate at least partially covered with a photosensitive opaque white coating, and exposing at least a point of the photosensitive opaque white layer to a first radiation, the radiation being able to perform ablation of the photosensitive opaque white layer, so that the point exposed to the radiation becomes transparent, and so that light passes through the thickness of the identity document at that point.

The invention relates to an identity document or identity card, particularly an identity document or card comprising a secondary portrait.

Such an identity document with secondary portrait is generally known from the prior art. It generally comprises a main image depicting the face of the bearer of the document, such as a first portrait, and a secondary portrait generally depicting the same image but generally with smaller dimensions. The main image and the secondary portrait are integrated into various layers of the document and produced using different technologies in order to make the document difficult to forge.

Producing a secondary portrait in a dedicated transparent window is known from the prior art EP3196044 and WO2018164574. Traditionally, the window is constructed by inserting a transparent insert into an opening cut or stamped out beforehand in the thickness of the opaque layers of the identity document. The secondary portrait is then produced using different technologies, such as by blackening a point or using a variable optical thin film in a transparent window.

One disadvantage with the use of a transparent window is that the window is a zone specifically dedicated to the secondary portrait. It is therefore absolutely essential for the dimensions of the secondary portrait to be matched to those of the transparent window. Another disadvantage is that the transparent window interferes with the printed surface of the card and creates a non-uniform background for the printing layer of the card. It is therefore necessary to take the size of the window into consideration with respect to the colour printing. The printing layer is applied in such a way as to avoid the window zone.

In addition, the surface area dedicated to said window is not available for printing or for personalizing the two sides of a document. Certain documents, such as identity cards, are relatively small. This unavailable surface area on the two faces of the card may be an unacceptable constraint such that transparent or translucent window technologies are excluded.

A solution described in document EP2001687 proposes a secondary portrait without a window. The secondary portrait is constructed by perforation in the thickness of the document. With this solution, there is no need to select a dedicated zone for the secondary portrait. Specifically, perforation can be performed on several zones of the identity document. Nevertheless, this solution renders the document mechanically weaker, and in particular, there is a high risk of breakage at this point under the effect of mechanical stress.

The invention seeks to provide an identity document comprising a secondary portrait without assigning a dedicated transparent zone to this secondary portrait or without removing surface area useful for printing, or without weakening the structure of the document by perforating.

The present invention overcomes these various disadvantages. To this end, a subject of the invention is a method for manufacturing an identity document, comprising a step consisting in providing a document body comprising at least a first and a second transparent external layer and a white central layer, the white central layer comprising a transparent substrate at least partially covered with a photosensitive opaque white coating, a step of exposing at least a point of the photosensitive opaque white coating to a first radiation, the radiation being able to perform ablation of the photosensitive opaque white coating, so that the point exposed to the radiation becomes transparent, and so that light can pass through the thickness of the identity document at that point.

By virtue of these features, it is possible to obtain a secondary portrait without weakening the structure of the body of the identity document. In addition, the photosensitive opaque white coating may also be used as a background for the identity document.

According to other features:
the coating is a thin film metal oxide layer applied to the transparent substrate,
the deposition of the thin metal oxide layer is obtained using plasma enhanced chemical vapour deposition,
the diameter of the point is less than 500 μm such that the point is not visible to the naked human eye under ambient lighting conditions but is visible when backlit with light more intense than the ambient light,
the first radiation is a laser radiation close to UV radiation, with a wavelength in the range from 190 to 400 nm, or close to IR radiation, with a wavelength in the range from 700 to 2500 nm, or close to green radiation with a wavelength in the range from 500 nm to 550 nm,
several points on the photosensitive opaque white coating are exposed to the first radiation in order to form a specific pattern,
the method comprises a step consisting in adding a filter between the white central layer and the first transparent external layer, the filter being able to block a second radiation different from the first radiation, and being able to transmit the first radiation,
the second laser radiation is a laser radiation close to UV laser radiation, with a wavelength comprised between 190 and 400 nm, or close to IR laser radiation, with a wavelength comprised between 700 and 2500 nm, or close to green radiation with a wavelength comprised between 500 nm and 550 nm,
at least one of either the first or the second transparent external layer comprises a substrate doped with additives sensitive to the second radiation, and comprising a step of exposing the substrate to the second radiation in order to turn the irradiated particles black and form at least a mark,
the white central layer consists of a substrate covered with the photosensitive opaque white coating over the entire surface of the central layer,
the white central layer consists of a white-tinted substrate comprising a window housing a transparent insert covered with a photosensitive opaque white coating,
the method comprises a step of applying a colour printing layer comprising at least one printing-free zone, a step of positioning the colour printing layer between the external layer and the white central layer, the printing-free zone facing the photosensitive opaque white coating of the central layer, a step of laminating the layers together to form the body of the document.

The invention also relates to a method for authenticating an identity document comprising the following steps: illuminating a first face of the identity document with light more intense than the ambient light, positioning a capture device on the second face of the document, having the capture device read the pattern formed by the rays of light that pass through the transparent points, checking that the pattern acquired corresponds to information pertaining to the document, issuing a positive response as to the validity of the document when correspondence is confirmed.

The invention also relates to an identity document comprising a white central layer and a first and second transparent external layer, the white central layer comprising a zone formed of at least one transparent supporting layer covered with a photosensitive opaque white coating, and transparent points created within the photosensitive opaque white coating so that light passes through the thickness of the identity document at that point.

According to other features:
the transparent points form a specific pattern,
the diameter of the points is less than 500 μm so that the points are not visible under ambient frontal lighting conditions but are visible when backlit with light more intense than the ambient light.

Other embodiments and advantages of the invention are described hereinafter with reference to the figures, in which:

FIG. 1 is a view from above of an identity document of the prior art,

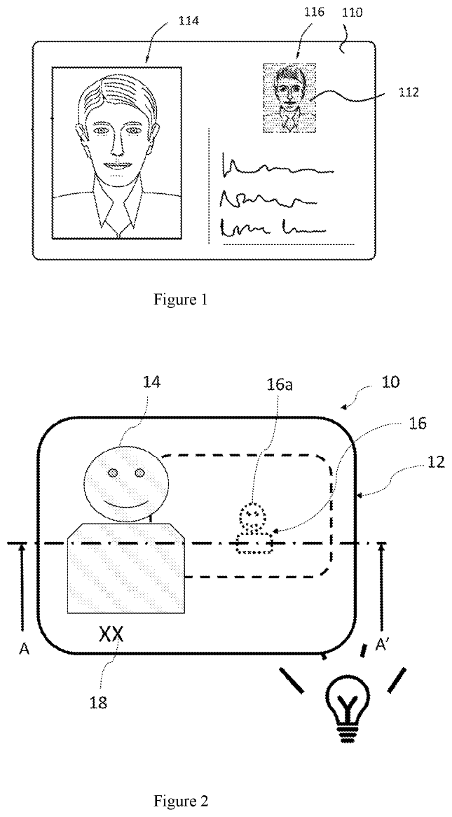

FIG. 2 is a view from above of an identity document according to the present invention.

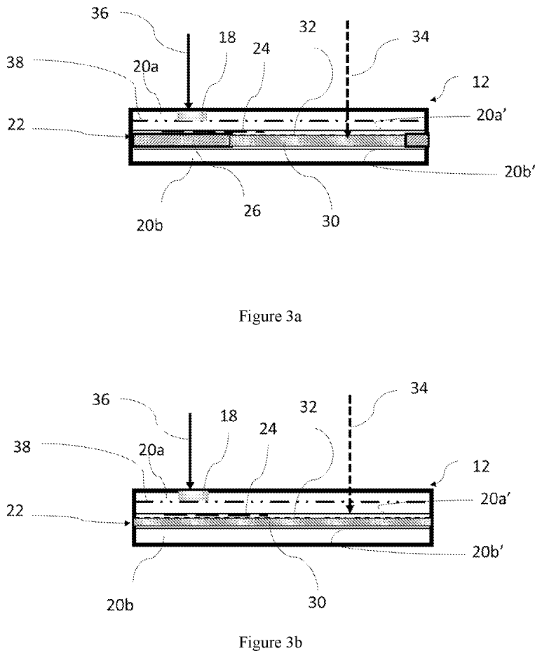

FIG. 3a is a view in section on AA′ of the identity document of FIG. 2.

FIG. 3b is a cross section through an identity document according to a second embodiment of the invention.

In order to improve clarity, the figures are not drawn to scale. Further, in the listed figures, features that are similar may bear the same reference.

The identity document according to the invention may be an identity card, a driving license, a bank card, a credit card, an identity card, an official document in the form of a booklet, such as a passport. These identity documents are used to verify the identity of their bearer.

In general, these identity documents comprise a flat body delimiting an upper face and a lower face, the body being formed by one or more layers made of PC, or PVC or PET or any combination of these materials. Usually, one face of the identity document comprises a first portrait such as an official photo of the bearer of the document, this first portrait conforming to certain specific government requirements. The remaining part of the face of the identity document comprises several security elements such as a secondary portrait of the bearer. This secondary portrait can be used to verify the authenticity of the identity document.

FIG. 1 shows an identity document 110 of the prior art. The identity document comprises a first portrait 114 and a second portrait 116. The first portrait 114 may be produced by printing on one of the layers of the identity document 110. The secondary portrait 116 may be produced in a dedicated window 112 by laser etching into one of the layers made for example of polycarbonate doped with a sensitive material for causing selective blackening.

As may be seen in FIG. 1, the window 112 is dedicated to housing the secondary portrait and is not suitable for housing the printing of the first portrait.

FIG. 2 shows a view from above of an upper face of an identity document 10 according to the invention. The identity document 10 comprises a body 12 equipped with a main image of the bearer in the form of a first portrait 14, with a secondary portrait 16 and with a number of visual features or marks 18.

The body 12 is made up of a stack of several substrates, as can be seen in FIG. 3a. In particular, FIG. 3a, which depicts a cross section through the card illustrated in FIG. 2, shows an identity document comprising three substrates. Each substrate may be made of a polymer material such as PVC, polycarbonate, PET or any combination of these materials.

As illustrated in FIG. 3a, the identity document according to the invention comprises a first and a second transparent external layer 20a, 20b and a white central layer 22. For the sake of better understanding, each substrate is depicted in FIG. 3a as having an internal face 20a′, 20b′. However, it must be understood that, at the interface between two substrates, the internal faces of the substrates are fused.

The first and second external layers 20a, 20b are used as protective layers to protect a colour printing layer 24 displaying various patterns such as a security element, a blazon indicative of nationality, a bank card logo and so on. The white central layer 22 is used as a neutral and opaque background for the printing layer 24. The white central layer 22 may be plain, mass-coloured, or made up of white layers sandwiching a transparent layer. The white layers are either made of white polymer or printed with white ink.

In FIG. 3a, the central layer 22 consists of a white-tinted layer 26 with an opening housing an insert 30 covering the white coating 32. As an alternative, the central layer 22 may consist of a transparent layer covered with an opaque white coating 32 over its entire surface, as illustrated in FIG. 3b. The opaque coating is able to be not on the surface but at some depth within the thickness of the insert 30.

The colour printing layer 24 is produced between the central layer 22 and one of the transparent external layers 20a, 20b. The printing may be done on the internal face of the first or of the second transparent external layer 20a, 20b or applied to the upper and/or lower face of the central layer 22. The transparent external layers 20a or 20b may technically be made up of several transparent layers, in which case the colour printing can be positioned at any one of the interfaces between these layers. The colour printing layer is depicted schematically in FIG. 2 as including a first portrait 14. Other images or patterns may be designed into the colour printing layer, such as security patterns containing guilloches or other printed security elements. As illustrated in FIG. 3a, the colour printing layer is applied to the interior side of the transparent external layer. However, it could be applied to the upper face of the central layer 22. The printing layer is applied by a printing method known in the prior art, such as screen-printing or offset printing.

As can be seen in FIGS. 2 and 3a, the colour printing straddles a white-tinted zone of the central layer 22 and a zone of the insert 30 that is covered with the opaque white coating 32. The white-tinted layer 26 and the white coating 32 are sufficiently opaque in the wavelength of visible light to block the transmission of the ambient light. Furthermore, the white-tinted layer 26 and the white coating 32 are used as primer for the colour printing layer in order to obtain a uniform printed colour free of variation. According to the invention, at least one region of the opaque white coating 32 is not covered with the printing. This region may be different for each identity document or batch of identity documents.

According to the invention, the opaque white coating 32 is produced as a thin layer of metal oxide, such as a metal oxide that forms a white pigment, applied to the insert 30 made of polymer. This thin layer has a thickness of a few nanometres.

The thin film of metal oxide is applied using a method known from the prior art, for example plasma deposition methods such as plasma enhanced PVD (physical vapour deposition).

As explained previously, the thin layer of metal oxide needs to form a neutral and opaque background for the colour printing layer 24. For that purpose, the thin metal oxide layer is produced so that it is opaque to the wavelengths of the visible spectrum. Furthermore, the thin film of metal oxide is sensitive to a first radiation 34 so that the thin film is rendered transparent when exposed to this first radiation 34. The first radiation 34 may be applied using a laser. When the first radiation 34 is applied to the thin film of metal oxide, in the region not covered by the printing, that zone of the thin film that is exposed to the first radiation 34 is locally converted to become transparent. It must be appreciated that the nature of the physical and/or chemical conversion that converts opacity to transparency is dependent on the type of metal oxide and on the type of radiation irradiating the zone. It may be local ablation of the metal oxide to form microperforations in the metal oxide film, or a modification to the crystal structure of the thin film of metal oxide leading to a change in the chemical composition of the thin film resulting in a discoloration or a local whitening of the pigments of the thin film of metal oxide. The zone modified by the radiation is limited/localized to the point of contact of the radiation with the thin film of metal oxide. This zone is therefore of very small dimensions, of the order of 500 μm in diameter, or in transverse dimension, and forms a point 16a.

The first and second external layers 20a, 20b are not sensitive to the first radiation 34 and do not react when exposed to the first radiation 34. This sensitivity is dependent not only on the wavelength but also on the energy. Specifically, either 20a and 20b are not sensitive to the radiation 34 or the sensitivity threshold is above the energy of the radiation 34 that is needed to perform ablation in the layer 32. Thanks to the structure described hereinabove, the personalization, partial destruction of the polymer layers or delamination of these polymer layers are avoided. Only the thin layer of metal oxide is locally converted by the radiation.

The radiation is applied using a laser technology emitting in the wavelengths of UV radiation (190 nm-400 nm), or infrared radiation (700 nm-2500 nm), or green radiation (500 nm-550 nm). The wavelength of the radiation will be chosen according to the properties of the thin film of metal oxide. In particular, the thin film of metal oxide needs to be sensitive to the laser radiation chosen.

Suitable movement to position the laser radiation at several points 16a on the metal oxide makes it possible to form a collection of discoloured and permanent points 16a which together form the outline of a pattern 16, such as a secondary portrait 16 illustrated in FIG. 2. The outline of the pattern 16 is produced in the part of the thin layer that is not covered with printing or that is covered over a very limited percentage of the surface area, with sparse guilloches for example.

Each of the transparent points 16a, has very small dimensions, less than around 500 μm in diameter or in transverse dimension. In consequence, under ambient light, these transparent points 16a are difficult for a human eye to see from a normal observation distance of the order of 30 to 40 cm with frontal illumination. This feature is advantageous because it allows a secondary portrait formed by the outline pattern 16 to be incorporated discretely, under ambient lighting, which is to say chiefly with frontal lighting, without modifying the general appearance of the identity document. Furthermore, the secondary portrait 16 is visible when exposed to lighting from behind that is more intense than the ambient lighting. To this end, a user can see the outline pattern 16 formed by the transparent points 16a when it is backlit. FIG. 2 illustrates the secondary portrait 16 when it is revealed.

Thanks to the very high precision of the laser ablation, it is possible to obtain a very clear and accurate outline for the point 16a, and therefore an outline 16 that is easily identifiable, which is to say that the points 16a are all present and clearly visible when backlit. The pattern 16 is not sensitive to specular reflection or to variations in lighting, which is to say that each point 16a is present and provides clear information. It is therefore possible to inspect and verify the outline pattern 16 very reliably. For example, it is possible to capture an image of the secondary portrait formed by the outline pattern 16 using a camera and to analyse the image in order to verify the authenticity of the identity document. The secondary portrait 16 acts as a signature that can be verified by a device that is easy to implement. This method will be described later on in the description.

According to one embodiment illustrated in FIGS. 2, 3a and 3b, the identity document comprises a mark 18 representing a visual feature that is visible to the user under ambient lighting. This mark 18 is illustrated in FIG. 2 by the letter “X”. This mark 18 is obtained by irradiating the first external layer 20a by means of a second radiation 36 different from the first radiation 34. This second radiation 36 is applied by a laser and chosen from a radiation with a UV wavelength (100 nm-400 nm), or infrared wavelength (780 nm-1 mm), or green wavelength (500 nm-550 nm). To this end, the first external layer 20a is a polymer doped with additives sensitive to the second laser radiation 36 and chosen so as to obtain coloration of the first transparent layer when irradiated with the laser. As an alternative, the layers 20a and 20b consist of a polymer which is naturally sensitive to the radiation 36 without containing an additive. For example, the additives to the polymer absorb the second laser radiation 36 and are carbonized when irradiated, thus becoming black. The first external layer 20a is therefore marked by the blackening of the irradiated zones. This mark 18 is represented by the letter “X” in FIG. 2.

According to a preferred embodiment, the first radiation 34 that causes ablation of the thin film of metal oxide is a UV radiation and the second radiation 36 that marks the first or the second external layer 20a, 20b is an infrared radiation.

According to another embodiment, the first radiation 34 that produces the ablation of the thin film of metal oxide in order to create the perforation is an IR radiation and the second radiation 36 that marks the first or the second external layer 20a, 20b is a UV radiation.

According to another embodiment, the first radiation 34 that produces the ablation of the thin film of metal oxide in order to create the perforation is a green radiation and the second radiation 36 that marks the first or the second external layer 20a, 20b is an IR radiation.

The present invention is not restricted to the combinations described hereinabove and it is conceivable to apply another type of radiation or different combinations of those described hereinabove.

A filter 40 is placed in the first transparent external layer 20a to prevent the central layer 22 from being marked by the second radiation 36. This filter 40 acts as a blocker blocking the second radiation 36. It is therefore impossible for the second radiation 36 to irradiate beyond the thickness of the filter 40 or to do so in sufficient proportions, so that the remaining energy of the radiation 36 is below the ablation threshold for the coating 32. Thanks to this feature, the second radiation 36 does not affect the central layer 22. This filter 40 is transparent to the first radiation 34 so that it does not prevent the first radiation 34 from reaching the thin layer of metal oxide.

According to a preferred embodiment, the filtering layer 40 blocks infrared radiation and is transparent to UV radiation. It is therefore possible to perforate the thin film of metal oxide using UV radiation while at the same time blocking the ability of the IR radiation to reach the thin layer which is too fragile to take the energy used for forming the marking.

The external layer 20a may be formed by the filter positioned between two substrates and then laminated together.

According to another embodiment, a demetallization grating is formed in the thin film of metal oxide. The demetallization grating may be intended to avoid the effects of delamination of the polymer layers. This grating is formed by very fine lines, for example lines of a few nanometres thick, where the metal oxide is removed. Thanks to this measure, the layers of polymer surrounding the thin film are in contact along the demetallization grating, ensuring good mutual adhesion of the layers.

The identity document described hereinabove is manufactured using the following steps:

First of all, the various layers of the body 12 of the identity document are provided. In particular, the method comprises a step of providing the first and second transparent external layers 20a, 20b, at least one of which comprises a filter layer 40 to block the second radiation 36, and a step of supplying the white central layer 22 which comprises at least a transparent substrate at least partially covered with an opaque white thin layer that is photosensitive to the first radiation 34.

The method of manufacture further comprises a step of positioning a printing layer 24 between the first external layer 20a and the central white layer 22. The printing layer 24 comprises a printing-free zone facing part of the photosensitive opaque white thin layer of the central layer 22.

The method of manufacture next comprises a step of laminating the layers together to form the body 12 of the document.

After the layers have been laminated together, the method of manufacture comprises a step of exposing the photosensitive thin layer to a first radiation 34, such as a laser radiation, the first radiation 34 being designed to produce ablation of the opaque white thin layer at a specific point, so that the point exposed to the first radiation 34 becomes transparent, and so that light passes through the thickness of the card at this point.

Several points are exposed to the first radiation 34 to form the outline pattern 16.

The outline pattern 16 obtained in the preceding step can be used for an authentication step. To that end, the invention also relates to a method for authenticating an identity document as described hereinabove. The authentication method comprises the following steps: the user illuminates a first face of the identity document with light that is more intense than the ambient light, such as indoor lighting or sunlight outdoors, for example using a smartphone flash. A capture device, such as another smartphone, is positioned over the second face of the identity document and captures the outline of the pattern formed by the various transparent points through which the rays of light pass. The outline acquired, or signature thereof, is compared against recorded reference data and if the reference data and the captured outline correspond, the validity of the identity document is confirmed.

1. Method for manufacturing an identity document, comprising a step consisting in providing a document body (12) comprising at least a first and a second transparent external layer (20a, 20b) and a white central layer (22), the white central layer (22) comprising a transparent substrate at least partially covered with a photosensitive opaque white coating (32),

2. a step of exposing at least a point of the photosensitive opaque white coating (32) to a first radiation (34), the radiation being able to perform ablation of the photosensitive opaque white coating (32), so that the point exposed to the radiation becomes transparent, and so that light can pass through the thickness of the identity document at that point.

3. Method for manufacturing an identity document according to claim 1, wherein the coating (32) is a thin film metal oxide layer applied to the transparent substrate.

4. Method for manufacturing an identity document according to claim 2, wherein the deposition of the thin metal oxide layer is obtained using plasma enhanced chemical vapour deposition.

5. Method for manufacturing an identity document according to one of claims 1 to 3, wherein the diameter of the point is less than 500 μm such that the point is not visible to the naked human eye under ambient lighting conditions but is visible when backlit with light more intense than the ambient light.

6. Method for manufacturing an identity document according to one of claims 1 to 4, wherein the first radiation (34) is a laser radiation close to UV radiation, with a wavelength in the range from 190 to 400 nm, or close to IR radiation, with a wavelength in the range from 700 to 2500 nm, or close to green radiation with a wavelength in the range from 500 nm to 550 nm.

7. Method for manufacturing an identity document according to one of claims 1 to 5, wherein several points on the photosensitive opaque white coating (32) are exposed to the first radiation (34) in order to form a specific pattern.

8. Method for manufacturing an identity document according to one of claims 1 to 6, comprising a step consisting in adding a filter (40) between the white central layer (22) and the first transparent external layer (20a), the filter (40) being able to block a second radiation (36) different from the first radiation (34), and being able to transmit the first radiation (34).

9. Method for manufacturing an identity document according to claim 7, wherein the second laser radiation is a laser radiation close to UV laser radiation, with a wavelength comprised between 190 and 400 nm, or close to IR laser radiation, with a wavelength comprised between 700 and 2500 nm, or close to green radiation with a wavelength comprised between 500 nm and 550 nm.

10. Method for manufacturing an identity document according to one of claims 1 to 8, wherein at least one of either the first or the second transparent external layer (20a, 20b) comprises a substrate doped with additives sensitive to the second radiation (36), and comprising a step of exposing the substrate to the second radiation (36) in order to turn the irradiated particles black and form at least a mark (18).

11. Method for manufacturing an identity document according to one of claims 1 to 9, wherein the white central layer (22) consists of a substrate covered with the photosensitive opaque white coating (32) over the entire surface of the central layer (22).

12. Method for manufacturing an identity document according to one of claims 1 to 9, wherein the white central layer (22) consists of a white-tinted substrate comprising a window housing a transparent insert (30) covered with the photosensitive opaque white coating (32).

13. Method for manufacturing an identity document according to one of claims 1 to 11, comprising

14. a step of applying a colour printing layer (24) comprising at least one printing-free zone,

15. a step of positioning the colour printing layer (24) between the external layer (20a) and the white central layer (22), the printing-free zone facing the photosensitive opaque white coating (32) of the central layer (22),

16. a step of laminating the layers together to form the body of the document (12).

17. Method for authenticating an identity document manufactured according to the method of one of claims 1 to 12, characterized in that it comprises the following steps:

18. illuminating a first face of the identity document with light more intense than the ambient light,

19. positioning a capture device on the second face of the document

20. having the capture device read the pattern (16) formed by the rays of light that pass through the transparent points (16a),

21. checking that the pattern (16) acquired corresponds to information pertaining to the document

22. issuing a positive response as to the validity of the document when correspondence is confirmed.

23. Identity document manufactured according to one of claims 1 to 12, comprising

24. a white central layer (22) and a first and second transparent external layer (20a, 20b),

25. the white central layer (22) comprising a zone formed of at least one transparent supporting layer covered with a photosensitive opaque white coating (32),

26. and transparent points (16a) created within the photosensitive opaque white layer (32) so that light passes through the thickness of the identity document at that point (16a).

27. Identity document according to claim 14, wherein the transparent points (16a) form a specific pattern (16).

28. Identity document according to one of claims 14 to 15, wherein the diameter of the points is less than 500 μm so that the points (16a) are not visible under ambient frontal lighting conditions but are visible when backlit with light more intense than the ambient light.
